(19) United States
(12) Patent Application Publication
(10) Pub. No.: US 2002/0095861 A1
(43) Pub. Date: Jul. 25, 2002

(54) Apparatus for protecting plants during cold weather

(76) Inventor: Roy D. Trussell, Wabeno, WI (US)

Correspondence Address: Roy Trussell, P.O. Box 234, Wabeno, WI, 54566, US

(21) Appl. No.: 09/770,118

(22) Filed: Jan. 23, 2001

(51) Int. Cl. A47G 7/08; A01C 1/00; A01G 1/00; A01G 13/00

(52) U.S. Cl. 47/1.01 R

(57) ABSTRACT

A tarp suitable for protecting plants during frost and freezing nights is disclosed. The tarp preferably comprises of two sheets that are stitched together at their perimeter to form insulative air gaps therebetween. The top sheet is preferably nylon reinforced polyethylene, coated with a white or metallic coating to reflect sunshine. The bottom sheet is preferably spun-bonded polypropylene. Such a tarp has shown suitable results in protecting plants from frost and freeze damage even without the use of supports or external heat sources, and may be laid directly onto sensitive plants. Yet, the reflective nature of the top sheet prevents the plants from growing too hot during those times of day when the tarp is exposed to direct sunlight. Additionally, the air gaps in between the top and bottom sheets may be replaced by a third layer of bubble wrap placed between the top and bottom sheets.

### FIELD OF THE INVENTION

This invention relates generally to a tarp to protect plants during frost and freezing nights.

### BACKGROUND OF THE INVENTION

It is well known to use tarps and other covers to protect plants from frost damage on cold nights. Such tarps are known to be beneficial because they collect the frost and hence protect plants and fruit from frost damage.

When a plastic tarp is used in this fashion, care must usually be taken to ensure that no part of the tarp touches the plants being protected. During frosty nights those portions of sensitive plants that come in contact with the tarp experience frost transfer therethrough, and may experience frost damage at the point of contact. Accordingly, it has previously been necessary to elevate the tarp on supports, such as wires or hoops, so that the tarp is suspended above the plants, but not in contact therewith. However, while the use of supports prevent frost damage at the point of contact between the plants and the tarp, this approach allows the ground heat to more easily escape, which can adversely affect the growing of sensitive plants and make the tarp ineffective when temperatures drop below freezing and into the 20-29 Fahrenheit temperature range. Thus, when supports are used it is sometimes necessary to provide an external heat source to make up for the excessive loss of ground heat. The use of supports and external heat sources are time consuming and add expense to the growing of plants.

What is needed therefore, is a tarp that prevents the plants from frost and freeze damage without the use of supports or external heat sources. The present disclosure presents such a tarp.

### SUMMARY OF THE INVENTION

The present invention comprises a tarp suitable for protecting plants during frost and freezing nights. The tarp preferably comprises of two sheets that are stitched together at their perimeter to form insulative air gaps therebetween. The top sheet is preferably nylon reinforced polyethylene, coated with a white or metallic coating to reflect sunlight. The bottom sheet is preferably spun-bonded polypropylene. Such a tarp has shown suitable results in protecting plants from frost and freeze damage even without the use of supports or external heat sources, and may be laid directly onto sensitive plants. Yet, the reflective nature of the top sheet prevents the plants from growing too hot during those times of day when the tarp is exposed to direct sunlight. Additionally, the air gaps in between the top and bottom sheets may be replaced by a third layer of bubble wrap placed between the top and bottom sheets.

### BRIEF DESCRIPTION OF THE DRAWINGS

FIG. 1 illustrates a first embodiment of the inventive tarp.

FIG. 2 illustrates the tarp of FIG. 1 in cross-section.

FIG. 3 illustrate a second embodiment of the inventive tarp in which the air gap is replaced by a layer of bubble wrap.

### DETAILED DESCRIPTION OF THE INVENTION

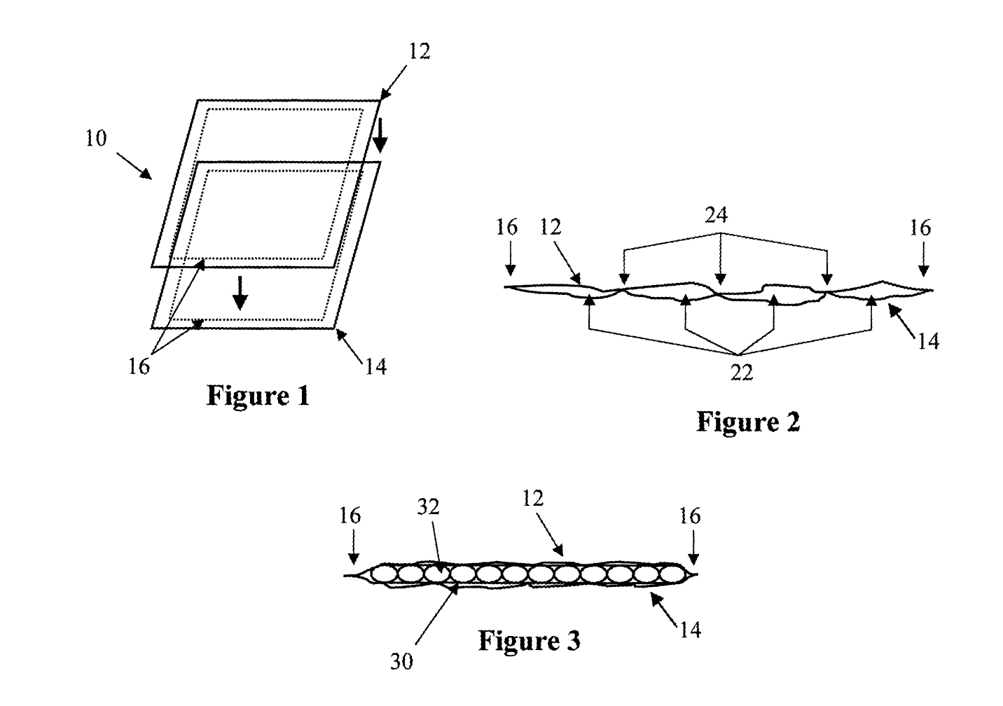

A first embodiment of the invention is shown in FIG. 1, which shows a tarp 10. Tarp 10 is comprised of two sheets, top sheet 12 and bottom sheet 14. Top sheet 12 is preferably comprised of nylon reinforced polyethylene (such as the sheets produced by America Tarp, Duraskrim R6WW), which is white or metallic silver in color to reflect sunlight. The bottom sheet 14 is preferably comprised of spun-bonded polypropylene (such as the sheets produced by Linq Fabrics, Typar 3201).

Sheets 12 and 14 can be attached in a number of ways, such as by tying or stapling, although at present it is preferred that they be stitched 16 at the perimeter as shown in FIG. 1. For larger tarps it may be necessary to further stitch sheets 12 and 14 at locations within the center of tarp 10, such as down the diagonal or across the middle of the tarp. Of course, the size of the tarp 10 should be commensurate with the size of the planting bed to be protected. A tarp measuring 10 feet by 30 feet has been shown to yield satisfactory results. With the tarp constructed in this fashion, it can be seen in cross section in FIG. 2 that tarp 10 will have air gaps 22 in between top sheet 12 and bottom sheet 14. Of course, the two sheets 12 and 14 will naturally come into contact at various portion 24 along the expanse of tarp 10, but the air gaps 22 will still predominate across the expanse of the tarp and provide suitable insulation.

The white or metallic silver color on the top sheet 12 reflects sunlight that could otherwise heat plants to an unsuitably high level if the tarp 10 was left on too long in the morning or during the day when it would be exposed to direct sunshine. Yet, the air gap 22 allow tarp 10 to rest directly on the surface of the plants without the risk of frost or freeze damage and without the use of supports or external heat sources. It is hypothesized that the air gaps 22 provides enough insulation to protect plants and fruit from freezing on nights when the temperature can drop into the 20s Fahrenheit. As noted previously, the top and bottom sheets 12 and 14 will naturally come in contact with each other at certain locations 24, but these points of contact are not expected to detract from the insulative effect of air gaps 22. When placing tarp 10 on the surface of the plants, it is preferable to place or affix the perimeter of tarp 10 to the ground to prevent the loss of ground heat during clod nights.

The polypropylene and polyethylene sheets that comprise bottom sheets 12 and 14 are suitably smooth such that they would not be expected to catch on objects such as vines or tops of the plants being protected, and hence, tarp 10 maybe easily cast over the plants in the evening and removed in the morning without damaging them. Moreover, such materials are easily folded without cracking, thus giving tarp 10 suitable ruggedness such that it can be used from year to year.

A second embodiment of the invention is shown in cross section in FIG. 3. In this embodiment, the air gaps 22 have been replaced by a layer of bubble wrap 30, such as is commonly used in the packaging of materials. A suitable bubble wrap layer 30 is manufactured by Sealed Air Corp. (SC-120 AS), and is 3/16 inch thick. Because bubble wrap 30 has a number of air bubbles or air-containing cells 32 within it, it also functions to form air gaps between the first and second sheets 12 and 14 as in the first embodiment disclosed above. It is expected that the second embodiment would be particularly useful in those cold weather applications in which extra insulation is required. While the bubble wrap layer 30 may be stitched along its perimeter to the top and bottom sheets as is generally illustrated in FIG. 1, the bubble wrap layer 30 may also float freely between the top and bottom layers, as shown in FIG. 3.

The disclosed tarp 10 can be used to protect a number of different plants such as tomatoes, peppers, green beans and small fruit trees. Depending on the plant to be protected, it maybe necessary to shape the tarp 10 in other than a flat plane as shown in the figures. For example, a dome or cylinder shaped tarp might be beneficial in protecting small trees. Also, tucks formed at the corners could make the tarp fit snugly over raised plant beds.

While different embodiments of the disclosed inventive tarp have been disclosed in this specification, it should be understood that these embodiments are merely illustrative and that other tarps can easily be made and used in accordance with the teaching of this specification without departing from the spirit of the invention. For example, one could form or affix ribs on the top or bottom sheets 12 or 14 to ensure that the sheets do not often come into contact, and hence that the insulative air gaps would be maintained. Accordingly, the scope of the present invention should not be limited by the disclosed embodiments, but instead should be judged in accordance with the following claims and equivalence thereto.

What is claimed is:

1. A tarp for protecting plants, comprising:
a top sheet, wherein the top sheet contains a surface reflective to sunlight;
a bottom sheet connected to the top sheet, wherein the bottom sheet rests on the plants being protected; and
air gaps in between the top and bottom sheets.

2. The tarp of claim 1, wherein the top sheet is polyethylene.

3. The tarp of claim 1, wherein the top sheet is polypropylene.

4. The tarp of claim 2, wherein the polyethylene is nylon reinforced.

5. The tarp of claim 3, wherein the polypropylene is spun-bonded,

6. The tarp of claim 1, wherein the reflective surface of the top sheet is white or metallic in color.

7. The tarp of claim 1, wherein the top sheet and the bottom sheet have perimeters and wherein they are connected by stitching at their perimeters.

8. A tarp for protecting plants, comprising:
a top sheet, wherein the top sheet contains a surface reflective to sunlight;
a bottom sheet connected to the top sheet, wherein the bottom sheet rests on the plants being protected; and
a middle sheet between the top and bottom sheets, wherein the middle sheet contains air gaps.

9. The tarp of claim 8, wherein the top sheet is polyethylene.

10. The tarp of claim 8, wherein the top sheet is polypropylene.

11. The tarp of claim 9, wherein the polyethylene is nylon reinforced.

12. The tarp of claim 10, wherein the polypropylene is spun-bonded,

13. The tarp of claim 8, wherein the reflective surface of the top sheet is white or metallic in color.

14. The tarp of claim 8, wherein the top sheet and the bottom sheet have perimeters and wherein they are connected by stitching at their perimeters.

15. The tarp of claim 8, wherein the middle sheet is bubble wrap.
